(19) United States
(12) Patent Application Publication
(10) Pub. No.: US 2006/0197644 A1
(43) Pub. Date: Sep. 7, 2006

(54) Flat inductor and the method for forming the same

(76) Inventor: Rex Lin, Taipei Hsien (TW)

Correspondence Address: REX LIN, 235 Chung-Ho, Box 8-24, Taipei, TW

(21) Appl. No.: 11/339,402

(22) Filed: Jan. 26, 2006

(30) Foreign Application Priority Data
Mar. 4, 2005 (TW) 094203284
Mar. 4, 2005 (TW) 094106505

(51) Int. Cl. H01F 27/24

(52) U.S. Cl. 336/212

(57) ABSTRACT

An inductor comprises a coil portion having two connecting leads; the two leads being bent inwards; a layer of insulating material coated upon surfaces of the coil portion and the two leads as an insulating layer; an layer of insulating enclosure enclosing the coil portion and the leads, end surfaces of the two leads being exposed out of the insulating enclosure; a magnetic guide seat formed by iron; the magnetic guide seat having a receiving chamber for receiving the insulating enclosure, the coil portion and the two leads, but the two end surfaces of the leads being exposed out of the magnetic guide seat; and a cover covering upon the receiving chamber so as to enclose the insulating enclosure within the magnetic guide seat, but the two end surfaces of the leads being exposed out from the cover. The method for forming the inductor is also included.

### FIELD OF THE INVENTION

The present invention relates to an inductor, wherein no enamel insulated wires is used. The surfaces of the coil portion and leads are coated with insulating layer so that no crack occurs. Thus the coil portion and the leads will not short-circuit to the magnetic guide seat. The leads are bent to have desired shapes and positions. In assembly, it is only necessary to locate the whole coil portion and leads of the inductor to the magnetic guide seat so that when the coil portion and leads are placed to the magnetic guide seat no other operation is necessary to adjust the leads and thus the structure formed by the magnetic guide seat and cover is concrete. Thereby the contact surfaces of the two leads are easily controlled to have the same elevation.

### BACKGROUND OF THE INVENTION

Flat inductors are widely used since they have smaller volumes and have wide conduction areas so as to suffer from great currents. Generally, an inductor is connected to a circuit.

Referring to FIGS. 1 and 2 the prior art flat inductor is illustrated. The prior art inductor has a coil portion 10 and two leads 11, 11a extended from the coil portion 10, an iron magnetic guide seat 12 and a cover 13. The magnetic guide seat 12 has an open type receiving chamber 121. An axis shaft 122 is installed in the receiving chamber 121 for receiving the coil portion 10. The leads 11, 11a extend out of the receiving chamber 121 and then are bent toward the cover 13 so as to be positioned upon a supporting plate 131 of the cover 13. Finally, iron powder glue is coated between the magnetic guide seat 12 and the cover 13 so as to combine the magnetic guide seat 12 and the cover 13.

However the prior art has the following disadvantages.

Firstly, in the prior art, the coil portion and leads are coated with enamel insulated wires so as to avoid the short circuit between the coil portion, leads and the magnetic guide seat. However the enamel insulated wires are easy to crack in the manufacturing process. Thereby the function of short-circuit-proof will be decreased so that the inductor cannot be operated successfully, even the circuit connected to the inductor will be destroyed.

The structure of the magnetic guide seat and cover formed by iron is weak. They are easy to break so that the quality of the product is unstable. Especially, in the assembly process, since the leads 10, 11 must be bent to be combined to the cover 13 (referring to FIG. 2), a force must be applied thereto so that the magnetic guide seat 12 and the cover 13 will be affected and they are easier to be destroyed.

Furthermore, the leads 10, 11 extend from the coil portion 10. The elevations of the leads 10, 11 are not equal. One is higher than the other. When the coil portion 10 is engaged to the axis shaft 122 of the magnetic guide seat 12, it is very difficult to bend the two leads 11, 11a to the supporting plate 131 of the cover 13 so that the two leads 11, 11a are retained at the same plane. The lengths of the two leads 11, 11a are not equal due to the errors in the manufacturing process of winding the coil portion. As a result the contact surfaces 111, 111a of the two leads 11, 11a, respectively, are not at the same plane. This generates a trouble when the inductor is connected to a circuit board.

### SUMMARY OF THE INVENTION

Accordingly, the primary object of the present invention is to provide an inductor, wherein no enamel insulated wires is used. The surfaces of the coil portion and leads are coated with insulating layer so that no crack occurs. Thus the coil portion and the leads will not short circuit to the magnetic guide seat. The leads are bent to have desired shapes and positions. In assembly, it is only necessary to locate the whole coil portion and leads to the magnetic guide seat so that when the coil portion and leads are placed to the magnetic guide seat no other operation is necessary to adjust the leads and thus the structure formed by the magnetic guide seat and cover is concrete. Thereby the contact surfaces of the two leads are easily controlled to have the same elevation.

To achieve above objects, the present invention provides an inductor which comprises a coil portion having two connecting leads; the two leads being bent inwards; and the gaps from the leads to the coil portion being identical; a layer of insulating material coated upon surfaces of the coil portion and the two leads as an insulating layer; an layer of insulating enclosure enclosing the coil portion and the leads, end surfaces of the two leads being exposed out of the insulating enclosure; a magnetic guide seat formed by iron; the magnetic guide seat having a receiving chamber for receiving the insulating enclosure, the coil portion and the two leads, but the two end surfaces of the leads being exposed out of the magnetic guide seat; and a cover covering upon the receiving chamber so as to enclose the insulating enclosure within the magnetic guide seat, but the two end surfaces of the leads being exposed out from the cover.

The method for forming the inductor is also included. The method comprises the steps of winding a bare conductive wire as a coil portion and two connecting leads extending from the coil portion; bending the two leads inwards, wherein gaps from the leads to the coil portion are identical; coating a layer of insulating material upon surfaces of the coil portion and the two leads as an insulating layer; forming an layer of insulating enclosure upon the coil portion and the leads of the inductor by molding injection, while exposing two end surfaces of the two leads, respectively; locating the insulating enclosure with the coil portion and the leads, in an iron magnetic guide seat; and covering a cover upon the insulating enclosure.

The various objects and advantages of the present invention will be more readily understood from the following detailed description when read in conjunction with the appended drawing.

### BRIEF DESCRIPTION OF THE DRAWINGS

FIG. 1 is an exploded perspective view of the prior art flat type inductor.

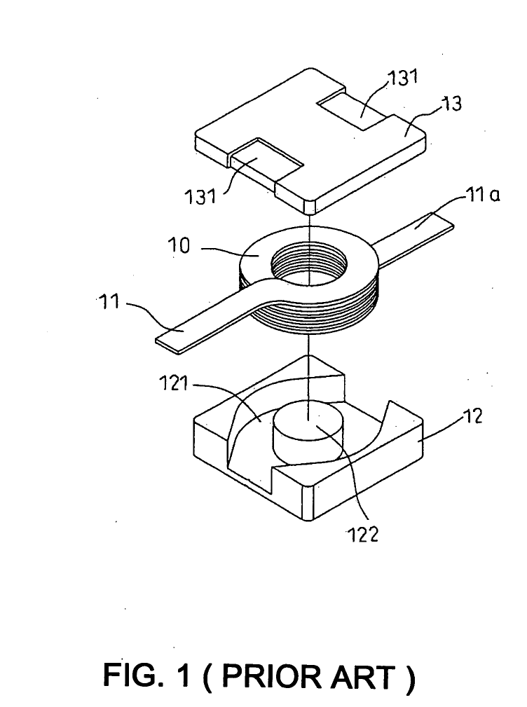

FIG. 2 is an assembled schematic view of the prior art in FIG. 1.

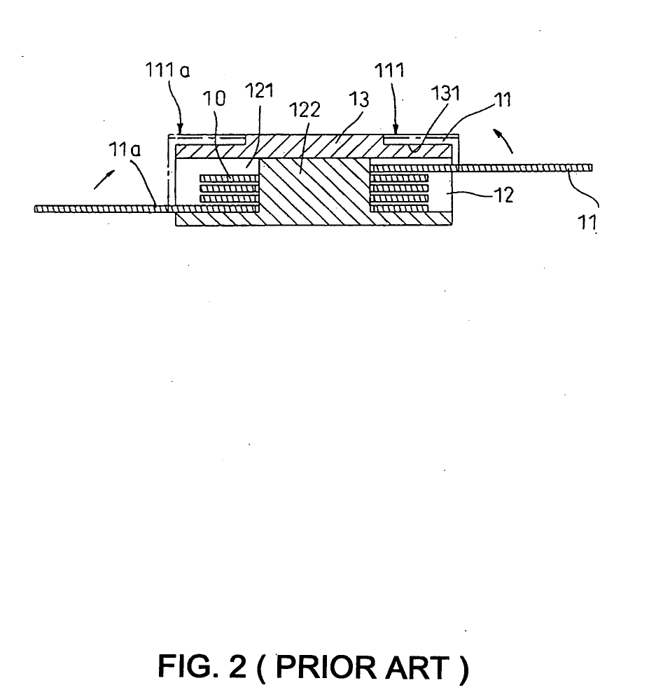

FIG. 3 is a perspective view of the present invention.

FIG. 4 is an exploded perspective view of the present invention

FIG. 5 shows the assembled view of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

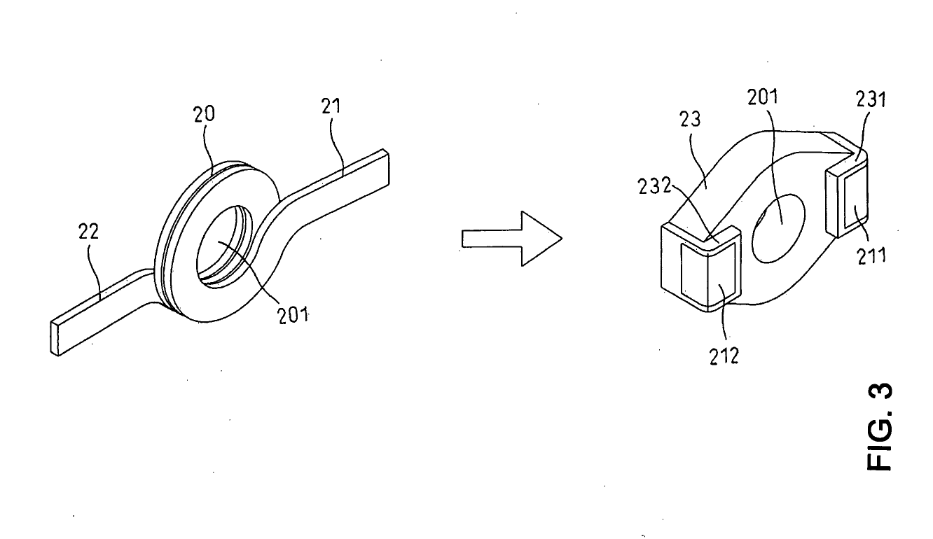

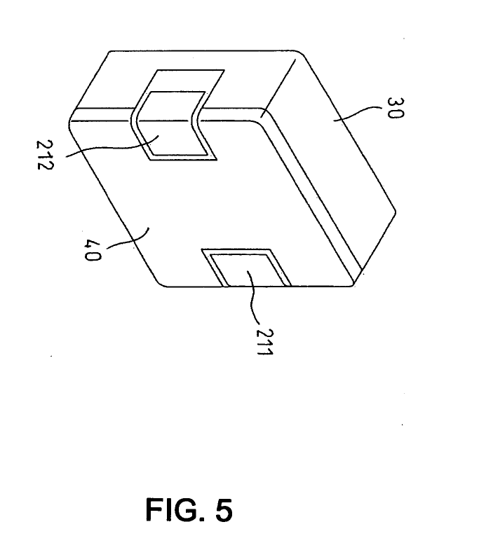

Referring to FIGS. 3 to 5, the inductor of the present invention is illustrated. The inductor has the following elements.

A coil portion 20 has two connecting leads 21, 22.

A magnetic guide seat 30 is formed by iron.

A cover 40 is included.

The manufacturing process of the inductor of the present invention comprises the following steps:

Winding a bare conductive wire as a coil portion 20 and two connecting leads 21, 22 extending from the coil portion 20.

Bending the two leads 21, 22 inwards. The gaps from the leads 21, 22 to the coil portion 20 are identical.

Coating a layer of insulating material upon surfaces of the coil portion 20 and the two leads 21, 22 as an insulating layer. The insulating material may be, for example, insulating paint.

Forming an layer of insulating enclosure 23 upon the coil portion 20 and the leads 20, 21 by molding injection, while exposing two end surfaces 211, 212 of the two leads 20, 21, respectively. The material of the insulating enclosure 23 may be for example insulating resin.

Locating the insulating enclosure 23 with the coil portion 20 and the leads 20, 21 in an iron magnetic guide seat 30.

Covering a cover 40 upon the insulating enclosure 23.

Plating tin to the end surfaces 211, 212 so as to be combined to a circuit board (for example a printed circuit board).

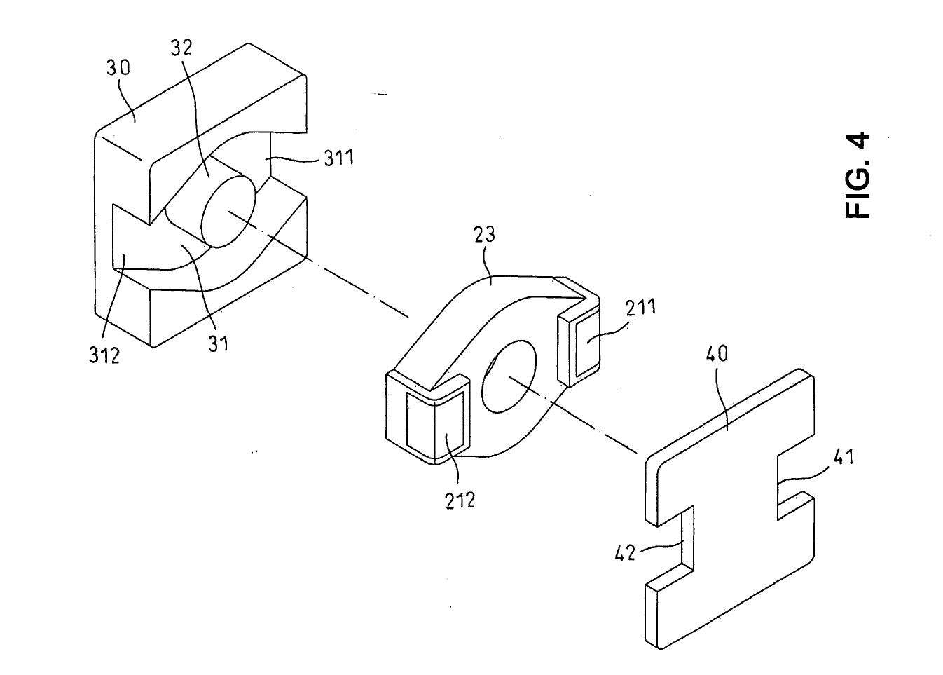

Referring to FIG. 4, in the present invention, the bending of the leads 20, 21 causes great end surfaces 211, 212 which make that the inductor has greater areas to contact a circuit board. Referring to FIG. 3, in the present invention, the lateral surfaces 231, 232 of the end surfaces 211, 212, respectively are adjusted to make the two end surfaces 211, 212 have the same height and have a preferred contact effect to an SMT surface of the circuit board.

Referring to FIG. 3, it is illustrated that the coil portion 20 has a hole 201 at a center portion thereof. The magnetic guide seat 30 is a receiving chamber 31 and an axial shaft 32 at a center of the receiving chamber 31.

Two sides 311, 312 of the receiving chamber 31 are symmetrical. The cover 40 has two notches 41, 42.

In assembly, the axial shaft 32 is inserted into the hole 201 so as to fix the insulating enclosure 23 with the coil portion 20 and leads 20, 21 to the magnetic guide seat 30. The two end surfaces 211, 21 are received in the two lateral sides 311, 312 of the receiving chamber 31. Then the cover covers upon an opening of the receiving chamber 31 so as to enclose the coil portion 20 and two end surfaces 20, 21 within the receiving chamber 31, while the two end surfaces 211, 212 are exposed out of the notches 41, 42 of the cover 40 as contact portions of the inductor. Preferably, the outer sides of the cover 40 and the magnetic guide seat 30 are coated with a layer of insulting paint so as to avoid the short circuit.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An inductor comprising:
a coil portion having two connecting leads; the two leads being bent inwards; and the gaps from each of the two leads to the coil portion being identical;
a layer of insulating material coated upon surfaces of the coil portion and the two leads as an insulating layer;
an layer of insulating enclosure enclosing the coil portion and the leads, end surfaces of the two leads being exposed out of the insulating enclosure;
a magnetic guide seat formed by iron; the magnetic guide seat having a receiving chamber for receiving the insulating enclosure, the coil portion and the two leads, but the two end surfaces of the leads being exposed out of the magnetic guide seat; and
a cover covering upon the receiving chamber so as to enclose the insulating enclosure within the magnetic guide seat, but the two end surfaces of the leads being exposed out from the cover.

2. The inductor as claimed in claim 1, wherein the coil portion has a hole at a center portion thereof and an axial shaft is formed at a center of the receiving chamber; and the axial shaft is inserted into the hole of the coil portion.

3. The inductor as claimed in claim 2, wherein two sides of the receiving chamber are symmetrical for receiving the two leads.

4. The inductor as claimed in claim 3, wherein the cover has two notches for exposing the two end surfaces of the two leads.

5. The inductor as claimed in claim 1, wherein the magnetic guide seat and cover are made of iron.

6. The inductor as claimed in claim 1, wherein the insulating enclosure is made of resin material.

7. The inductor as claimed in claim 1, wherein outer sides of the cover and the magnetic guide seat are coated with a layer of insulting paint so as to avoid the short circuit.

8. A method for forming an inductor comprising the steps of:
winding a bare conductive wire as a coil portion and two connecting leads extending from the coil portion;
bending the two leads inwards, wherein gaps from the leads to the coil portion are identical;
coating a layer of insulating material upon surfaces of the coil portion and the two leads as an insulating layer;
forming an layer of insulating enclosure upon the coil portion and the leads by molding injection, while exposing two end surfaces of the two leads, respectively;
locating the insulating enclosure with the coil portion and the leads, in an iron magnetic guide seat; and
covering a cover upon the insulating enclosure.

9. The inductor as claimed in claim 8, wherein the lateral surfaces of the end surfaces, respectively are adjusted to make the two end surfaces have the same height and the two end surface are as contact surfaces to contact surfaces of a circuit board.

10. The inductor as claimed in claim 8, wherein the insulating enclosure is made of resin.
